(19) United States
(12) Patent Application Publication
(10) Pub. No.: US 2017/0267791 A1
(43) Pub. Date: Sep. 21, 2017

(54) METHOD FOR PREPARING HIGH ACTIVITY ETHYLENE POLYMERIZATION CATALYST

(71) Applicant: PTT GLOBAL CHEMICAL PUBLIC COMPANY LIMITED, Bangkok (TH)

(72) Inventors: Sutheerawat Samingprai, Bangkok (TH); Tienkul Kangwanwong, Bangkok (TH); Nared Phetrak, Bangkok (TH)

(73) Assignee: PTT GLOBAL CHEMICAL PUBLIC COMPANY LIMITED, Bangkok (TH)

(21) Appl. No.: 15/508,790

(22) PCT Filed: Sep. 4, 2015
(86) PCT No.: PCT/TH2015/000055

§ 371 Date: Mar. 3, 2017

(30) Foreign Application Priority Data
Sep. 4, 2014 (TH) 1401005145

(51) Int. Cl. C08F 10/02

(52) U.S. Cl. CPC C08F 10/02

(57) ABSTRACT

The present invention relates to a method for preparing a high activity olefin polymerization catalyst, which is easy to be produced, reducing complicated steps, and can be produced at low temperature, wherein said method comprising the following steps: • (a) adding a magnesium halide into an alcohol solvent; • (b) precipitating the solution obtained from (a) in a solution of an organic solvent containing an organo compound of group III element; • (c) adding a titanium compound into the mixture obtained from (b) to obtain a catalyst; • (d) treating the catalyst obtained from (c) with an organoaluminium compound at a temperature ranging from 0 to 60° C. for 2 to 5 hours, wherein the mole ratio of aluminium to titanium (Al/Ti) for treatment is in a range of 1 to 30.

### FIELD OF THE INVENTION

The present invention relates to chemical mixture and chemical process for preparing high activity olefin polymerization catalyst.

### BACKGROUND OF THE INVENTION

It is well known that physical property and mechanical property of polymer depends on catalyst used in polymerization reaction. Therefore, there are attempts to the study and development of catalytic system for good characteristics of prepared polymer which is appropriate to the industrial requirement.

Until present, there has been well known reported that Ziegler-Natta catalyst is the suitable catalyst for polyolefin polymerization process. However, preparation of industrial polyolefin using said catalyst always have problem in the formation of low molecular weight polyolefin or wax as by-product, which are cheap and unwanted products. Therefore, high activity catalyst has been developed to overcome such problem.

Moreover, using Ziegler-Natta catalyst always results in a broad molecular weight distribution polymer which is a limitation to the applications that need narrow molecular weight distribution polymer such as nonwoven, monofilament, and injection. Therefore, there are many attempts to overcome said problem where maintaining high activity of catalyst.

U.S. Pat. No. 6,429,270 disclosed a method for improving Ziegler-Natta catalyst by using at least 2 supports together with treating the catalyst with organoaluminium compound and an electron donor having silicon as a component. It was found that the catalyst prepared by said method gave high activity for propylene polymerization. However, improving of catalyst according to said invention comprised with many steps, made it difficult in preparation, and was limitation in preparation of catalyst for using in industrial scale.

European patent number EP2428526 disclosed a preparation method for polyethylene with homogeneity using Ziegler-Natta catalyst which is contacted with organoaluminium compound and activated partial polymerization reaction with ethylene before substantial reaction in multi-stages reactor. However, said process comprised many steps, making it difficult and complicated for the preparation.

U.S. Pat. No. 6,916,895 disclosed a preparation method for Ziegler-Natta catalyst that is able to modify molecular weight distribution of polyolefin by controlling size and morphology of the catalyst. Said process comprising the following steps: treating magnesium dialkoxide compound with titanium compound and organoaluminium compound, then treating at high temperature of about 90 to 150° C. for about 30 minutes to 2 hours. However, said process comprised many steps and need high temperature treatment which could be difficult for industrial scale, including higher production cost which is limitation of this invention.

U.S. Pat. No. 7,365,138 disclosed an improving method for Ziegler-Natta catalyst by contacting the catalyst with organoaluminium compound and/or olefin before using as the catalyst for olefin polymerization. This was found that the catalyst of said method could reduce the formation of small particle of polymer. However, said catalyst had low activity.

From all above, this invention aims to improve an olefin polymerization catalyst to have high activity, whereas polyolefin obtained from said catalyst have narrow molecular weight distribution. Said process can be performed easily, reducing complicated steps, and can be performed at low temperature.

### SUMMARY OF INVENTION

The present invention relates to a method for preparing high activity olefin polymerization catalyst, said method comprising the following steps:

(a) adding magnesium halide into alcohol solvent;

(b) precipitating solution from (a) in solution of organic solvent containing organo compound of group III element;

(c) adding titanium compound into mixture from (b) to obtain a catalyst;

(d) treating the catalyst obtained from (c) with organoaluminium compound at temperature ranging from 0 to 60° C. for 2 to 5 hours, wherein a mole ratio of aluminium to titanium (Al/Ti) for treatment is in a range of 1 to 30.

### BRIEF DESCRIPTION OF THE DRAWINGS

FIG. 1 shows activation percentage of the catalyst after reacting with TEA in different times, wherein the mole ratio of Al/Ti for treatment is 5 and treatment temperature is at room temperature.

FIG. 2 shows activation percentage of the catalyst after reacting with TEA in different times, wherein the mole ratio of Al/Ti for treatment is 1 and treatment temperature is 0° C.

FIG. 3 shows the results of the mole ratio of Al/Ti to activation percentage after reacting with TEA.

FIG. 4 shows TREF-GPC chromatogram showing molecular weight distribution of the polymer.

FIG. 5 shows tensile modulus property of the polymer resulted from the catalyst according to the invention.

FIG. 6 shows tensile strength at yield point property of the polymer resulted from the catalyst according to the invention.

### DETAILED DESCRIPTION OF THE INVENTION

The present invention relates to a method for preparing high activity olefin polymerization catalyst which can be described by the following aspects.

Any aspect showed here aims to include other aspects of this invention unless stated otherwise.

### Definition

All technical and scientific terms used herein have the meaning that will be understood by those ordinary skilled in the art unless it has been defined otherwise.

Any instrument, equipment, method or chemical mentioned herein, unless indicated otherwise, shall mean instrument, equipment, method or chemical that are generally used or practiced by a person skilled in the art of this field unless stated otherwise that they are tools, equipment, methods, or chemicals specific only in this invention.

Use of singular nouns or pronouns when used with “comprising” in claims and/or specification means “one” and will also include “one or more”, “at least one”, and “one or more than one”.

Any method, process or step according to any process performed in this invention, unless specifically indicated otherwise, shall mean to perform under an inert atmosphere.

All compositions and/or methods disclosed and claimed in this application are intended to cover aspects of the invention obtained from performing, operating, modifying, changing any factors without experimentations that are significantly different from this invention, and acquire the same which have properties, utilities, advantages and results similar to the aspects of the present invention according to those ordinary skilled in the art even without being indicated in claims specifically. Therefore, the substitution for or similarity to the aspects of the present invention including minor modification or change that can be apparent to a person skilled in the art in this field shall be considered under the intention, concept and scope of this invention as appeared in the appended claims.

Throughout this application, the term “about” used to indicate any value that is appeared or expressed herein may be varied or deviated, which the variation or deviation may occur from the error of instruments and methods used to determine various values.

Hereafter, invention embodiments are shown without any purpose to limit any scope of the invention.

The present invention relates to a method for preparing high activity olefin polymerization catalyst, said method comprising the following steps:

(a) adding magnesium halide into alcohol solvent;

(b) precipitating solution from (a) in solution of organic solvent containing organo compound of group III element;

(c) adding titanium compound into mixture from (b) to obtain a catalyst;

(d) treating the catalyst obtained from (c) with organoaluminium compound at temperature ranging from 0 to 60° C. for 2 to 5 hours, wherein a mole ratio of aluminium to titanium (Al/Ti) for treatment is in a range of 1 to 30.

In one aspect of the invention, magnesium halide in step (a) may be selected from magnesium dichloride, magnesium dibromide, phenoxy magnesium chloride, isopropoxy magnesium chloride, butoxy magnesium chloride, or a mixture thereof.

Preferable, magnesium halide is magnesium dichloride.

In one aspect, alcohol solvent in step (a) may be selected from, but not limited to ethanol, isopropanol, butanol, hexanol, 2-hexanol, octanol, or a mixture thereof.

Organo compound of group III element in step (b) is alkyl compound of group III element, tris(halophenyl)borane, or alkylaluminium alkoxide, dialkylaluminium chloride, or a mixture thereof.

In one aspect, organo compound of group III element in step (b) is alkyl compound of group III element which can be selected from, but not limited to trimethylaluminium, triethylaluminium, triisobutylaluminium, tripropylaluminium, trimethylborane, triethylborane, triisobutylborane, or a mixture thereof.

In one aspect, organo compound of group III element in step (b) is tris(halophenyl)borane which can be selected from, but not limited to tris(pentafluorophenyl)borane, tris(trifluoromethylphenyl)borane, tris(tetrafluoroxylyl)borane, tris(tetrafluoro-o-tolyl)borane, or a mixture thereof.

In one aspect, organo compound of group III element in step (b) is alkylaluminium alkoxide which can be selected from, but not limited to diethylaluminium ethoxide, ethylaluminium diethoxide, diisobutyl aluminium ethoxide, or a mixture thereof.

Preferable, organo compound of group III element in step (b) is dialkylaluminium chloride which is selected from dimethylaluminium chloride, diethylaluminium chloride, diisobutylaluminium chloride, or a mixture thereof, most preferable is diethylaluminium chloride.

Titanium compound in step (c) is titanium alkoxide having at least one atom of chlorine, titanium halide, or a mixture thereof.

In one aspect, titanium compound in step (c) is titanium alkoxide having at least one atom of chlorine which can be selected from, but not limited to trialkoxy titanium monochloride, dialkoxy titanium dichloride, alkoxy titanium trichloride, or a mixture thereof.

In one aspect, titanium compound in step (c) is titanium halide which can be selected from, but not limited to titanium chloride, titanium bromide, or a mixture thereof, preferable is titanium chloride.

Organoaluminium compound in step (d) is triakylaluminium, alkylaluminium alkoxide, alkylaluminium halide, or a mixture thereof.

Preferable, organoaluminium compound in step (d) is triakylaluminium which is selected from, but not limited to trimethylaluminium, triethylaluminium, triisobutylaluminium, tripropylaluminium, or a mixture thereof, most preferable is triethylaluminium.

In one aspect, organoaluminium compound in step (d) is alkylaluminium alkoxide which is selected from, but not limited to diethylaluminium ethoxide, ethylaluminium diethoxide, diisobutyl aluminum ethoxide, or mixture of said compounds.

In one aspect, organoaluminium compound in step (d) is alkylaluminium halide which is selected from, but not limited to dimethylaluminium chloride, diethylaluminium chloride, diisobutylaluminium chloride, methylaluminium dichloride, ethylaluminium dichloride, isobutylaluminium dichloride, aluminium trichloride, or a mixture thereof.

In one aspect of the invention, a mole ratio of aluminium to titanium for treating in step (d) is in the range of about 1 to 10, and preferable is in the range of about 1 to 5.

In one aspect of the invention, the treatment temperature in step (d) is in the range of about 0° C. to room temperature, and preferable the treatment temperature is at ambient temperature.

Preferable, the treatment time in step (d) is in the range of about 2 to 3 hours.

In each step of the catalyst preparation in this invention, unless stated otherwise, organic solvent that may be selected include, but not limited to aromatic hydrocarbon, aliphatic hydrocarbon, cyclic hydrocarbon, preferable are toluene, benzene, ethylbenzene, cumene, xylene, hexane, cyclohexane, cyclohexene, heptane, or octane.

In one embodiment, said catalyst preparation may further comprising a drying step of catalyst from step (d) which can be selected from, but not limited to stirring evaporation, vacuum drying, freeze drying, etc.

In another aspect of the invention, the invention relates to the use of catalyst prepared according to the invention for olefin polymerization reaction, wherein said catalyst may be used in the form of liquid, semi-liquid, or solid.

In one aspect, olefin polymerization reaction may be operated in reactor in liquid phase, gas phase, or slurry phase, and may be operated in batch or continuous process.

In one aspect, olefin may be selected from ethylene, propylene, 1-butene, 1-pentene, 1-hexene, 1-octene, or a mixture thereof. Preferable, olefin is ethylene.

The following examples aim for explanation purpose of this invention only, not to be limitation of this invention in anyway.

Catalyst Sample Preparation

The present invention prepares high activity olefin polymerization catalyst by treating the catalyst by contacting with organoaluminium compound, wherein said catalyst may be prepared by a method described in the following comparative example Cat NT.

Comparative Example Cat NT

About 10 g of magnesium chloride (MgCl₂) was added into about 37 ml of anhydrous ethanol at room temperature. Then, heated at temperature about 90 to 100° C. while stirring to dissolve MgCl₂ solution and made it to be homogenized solution. Then, said solution was slowly added into mixture of about 160 ml of heptane and about 40 ml of diethyl aluminium chloride (DEAC) that had been temperature controlled in the range about 0 to 10° C. Once the addition had been performed, the reaction was left at room temperature for at least 1 hour, and resulted solid was washed at least 2 times by using about 200 ml of heptane, then added with 200 ml of heptane, following by about 35 ml of titanium tetrachloride (TiCl₄). Then, said mixture was refluxed at about 90 to 100° C. for 1 hour. Resulted solid was washed at temperature of about 90 to 100° C. with at least 200 mL of heptane until there was no titanium found in washing solution. Then, it was dried under vacuum to give the catalyst as a final product.

Catalyst Preparation According to the Invention

The catalyst according to the invention could be prepared by treating catalyst prepared from the above method by exposing to triethyl aluminium.

About 0.25 g of comparison catalyst Cat NT was suspended in 100 ml of hexane or heptane. Then, triethyl aluminium (TEA) was added at a mole ratio of aluminum to titanium (Al/Ti) as prescribed. The catalyst would change from white to grey-brown. Thereafter, said mixture was stirred at temperature is in the range of 0 to 60° C. for 2 to 5 hours. Resulted catalyst is analyzed for activation percentage and/or for ethylene polymerization.

Ethylene Polymerization

Ethylene polymerization can be done by using the following conditions, wherein hexane, the catalyst, and triethyl aluminium were added into a reactor. Then, heating the reactor to the predetermined temperature while ethylene was fed continuously into the reactor. Resulted polymer product was filtered and dried.

| | | |
|---|---|---|
| size of reactor | 5 | liters |
| feeding of hexane | 2.5 | liters |
| feeding of catalyst | 0.1 | mmol/liter |
| feeding of TEA | 1 | mmol/liter |
| feeding of hydrogen | 0.35 | MPa |
| feeding of ethylene | 0.45 | MPa |
| reaction temperature | 80° | C. |
| reaction time | 120 | minutes |

Hereafter, properties of the catalyst and polymer obtained from the catalyst according to invention would be tested, wherein a method and equipment are commonly used and not intended to limit the scope of invention.

Activation Percentage of Catalyst Treated by TEA

About 0.15 to 0.23 g of catalyst according to the invention was mixed with about 10 ml of isopropanol, about 30 ml of 6 molar sulfuric acid solution (H₂SO₄), and about 30 ml of deionized water was titrated with 0.1 M Ce(SO₄)₂.4H₂O standard solution wherein diphenylamine was used as an indicator. The solution was turned to be dark-blue color at the end point.

Analysis of Molecular Weight (Mw) and Molecular Weight Distribution (MWD) of Polymer

Molecular weight and molecular weight distribution of polymer were determined using gel permeation chromatography (GPC), Model of Polymer Char GPC-IR using column PLgel 10 μM MIXED-B and PLgel 10 μm Guard, at temperature about 140° C., using 1,2,4-trichlorobenzene (TCB) as an eluent, flow rate at 1 ml/min. Measured molecular weight was compared with molecular weight graph from polyethylene standard from Polymer Laboratory which covered molecular weight in the range of 540 to 2,000,000.

Analysis of Polymer Density

Polymer density was determined using Julabo FT50 according to ASTM D1505 standard.

Analysis of Melt Flow Rate (MFR) of Polymer

Melt flow rate of polymer could be determined using CEAST 7027 according to ASTM D1238 standard.

Analysis of Homogeneity of Polymer

Homogeneity of polymer could be determined using temperature rising elution fractionation—gel permeation chromatography (TREF-GPC), Polymer Char CFC, using column PLgel 10 μm MIXED-B and PLgel 10 μm Guard at temperature of 140° C., using 1,2,4-trichlorobenzene as an eluent, flow rate at 1 ml/min. Measured molecular weight was compared with molecular weight graph from polyethylene standard from Polymer Laboratory covering molecular weight in the range of 540 to 2,000,000.

Analysis of Tensile Modulus and Tensile Strength of Polymer

Tensile modulus and tensile strength of polymer could be determined using Zwick Z050E. Polymer sample was prepared to be a sample with 3 mm thickness before being tested according to ASTM D638 standard.

Time and Temperature for Treatment of Catalyst

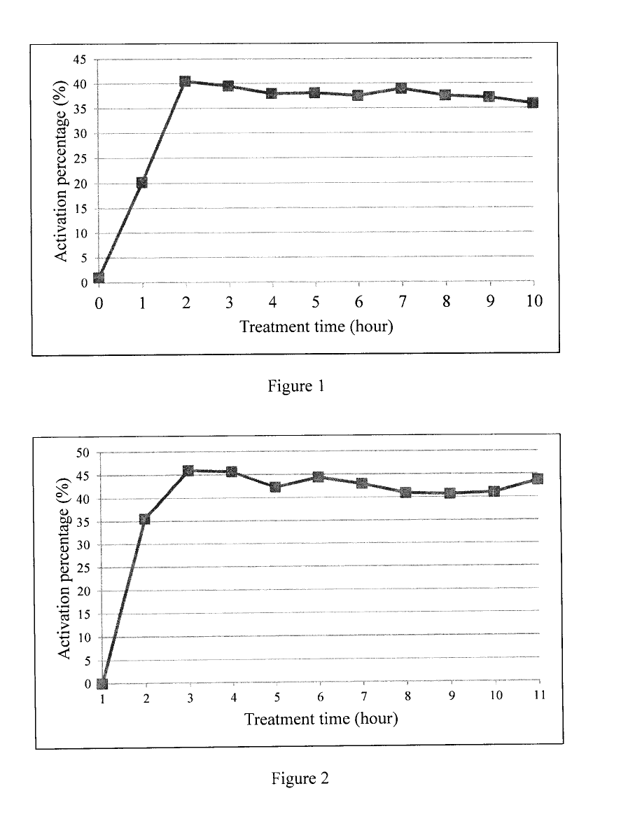

The catalyst was prepared according to the invention as described above, wherein the mole ratio of aluminium to titanium (Al/Ti) in the treatment is 5 to 1, and treatment temperature is at room temperature and 0° C. respectively. Then, the samples were collected for the analysis of reaction percentage of catalyst and TEA at different times. The result was shown in FIGS. 1 and 2.

The Mole Ratio of Aluminium to Titanium (Al/Ti) for Treatment

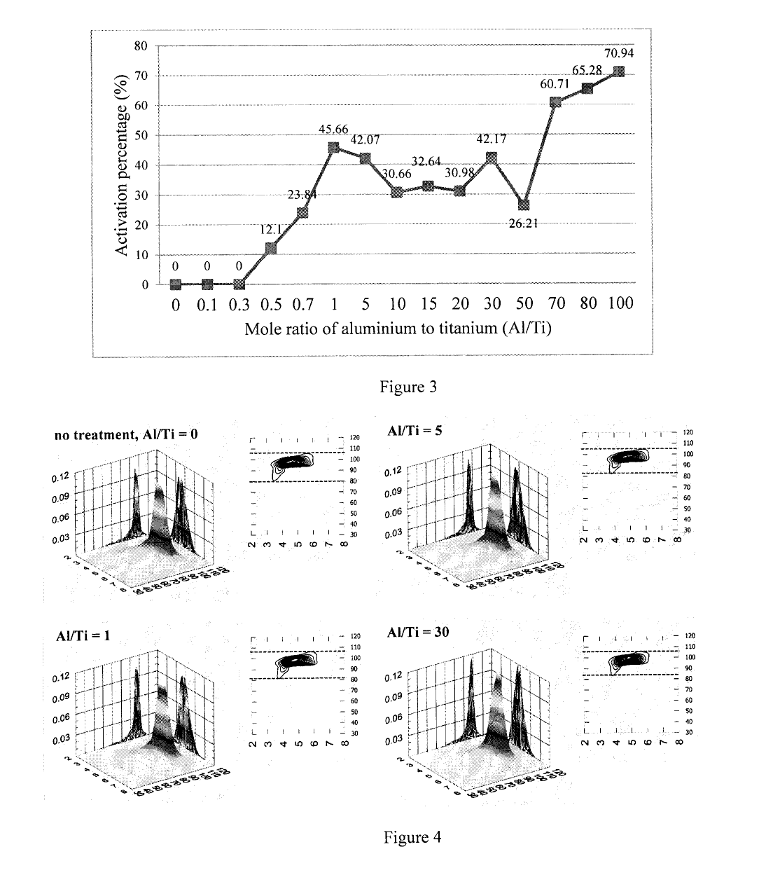

For the study of the mole ratio of aluminium to titanium that is suitable for preparing catalyst according to the invention, different mole ratios of Al/Ti were used in the preparation of the catalyst according to the invention as described above. At 3 hours of treatment at room temperature, the result was shown as FIG. 3, it was found that the reaction percentage of catalyst and TEA related to the mole ratio of Al/Ti for treatment.

Catalyst Activity and Polymer Properties

To show catalyst activity for ethylene polymerization and polymer properties from catalyst according to the invention, comparative example Cat NT was used in comparison with catalyst according to the invention such as example Cat T1, Cat T2, Cat T3, Cat T4, Cat T5, Cat T6, and Cat T7. Treatment time was controlled to be 3 hours and treatment temperature was room temperature at different mole ratios of Al/Ti wherein said catalyst was used in ethylene polymerization. The result was shown in Table 1.

TABLE 1
Catalyst activity and polymer
properties resulted from different catalysts

| | Mole | | | | | | |
|---|---|---|---|---|---|---|---|
| | ratio | Reaction | | | | | |
| | of Al/Ti | rate | | | | | |
| | used | (gPE/ | Properties of prepared polymer | | | | |
| | in the | mmol | Density | Mw | Mn | Mz | MWD |
| Catalyst | treatment | Ti · h) | (g/cm³) | (g/mol) | (g/mol) | (g/mol) | (Mw/Mn) |
| Comparative | — | 20,300 | 0.9601 | 122,231 | 7,723 | 696,219 | 15.83 |
| Example | | | | | | | |
| Cat NT | | | | | | | |
| Example | 1 | 28,500 | 0.9615 | 125,851 | 9,552 | 698,730 | 13.18 |
| Cat T1 | | | | | | | |
| Example | 5 | 23,500 | 0.9610 | 118,100 | 8,707 | 653,406 | 13.56 |
| Cat T2 | | | | | | | |
| Example | 30 | 20,000 | 0.9660 | 98,210 | 7,173 | 549,174 | 13.69 |
| Cat T3 | | | | | | | |
| Example | 50 | 19,000 | 0.9600 | 109,791 | 9,862 | 513,752 | 11.13 |
| Cat T4 | | | | | | | |
| Example | 70 | 18,200 | 0.9600 | 130,324 | 11,753 | 653,440 | 11.09 |
| Cat T5 | | | | | | | |
| Example | 80 | 16,400 | 0.9630 | 113,160 | 10,068 | 615,517 | 11.24 |
| Cat T6 | | | | | | | |
| Example | 100 | 13,600 | 0.9618 | 102,153 | 9,701 | 563,083 | 12.75 |
| Cat T7 | | | | | | | |

From Table 1, when compared comparative example Cat NT to example Cat T1, Cat T2, and Cat T3, it can be found that catalyst treated with organoaluminium at the mole ratio of Al/Ti in the range of 1 to 30 showed more activity and lower molecular weight distribution.

Next, the result from the analysis of molecular weight distribution of polymer using TREF-GPC is showed in Table 2.

TABLE 2
Soluble fraction of polymer from TREF-GPC analysis

| | Weight percentage of soluble fraction of polymer | | | |
|---|---|---|---|---|
| | | 70° C. ≦ | 80° C. ≦ | Tempera- |
| | Tempera- | Temperature < | Temperature ≦ | ture > |
| Catalyst | ture <70° C. | 80° C. | 100° C. | 100° C. |
| Comparative | 3.58 | 7.29 | 80.61 | 8.52 |
| Example | | | | |
| Cat NT | | | | |
| Example | 0.53 | 8.30 | 83.99 | 7.18 |
| Cat T1 | | | | |
| Example | 0.60 | 8.75 | 83.31 | 7.34 |
| Cat T2 | | | | |
| Example | 0.40 | 8.53 | 82.53 | 8.54 |
| Cat T3 | | | | |

When considering Table 2 with FIG. 4, it is found that the catalyst according to the invention Cat T1, Cat T2, and Cat T3 gave less soluble fraction of polymer in low temperature range (less than 70° C.) and high temperature range (more than 100° C.). It shows that polymer resulted from the catalyst according to the invention improved molecular weight distribution of polymer when comparing to the catalyst not treated with organoaluminium compound.

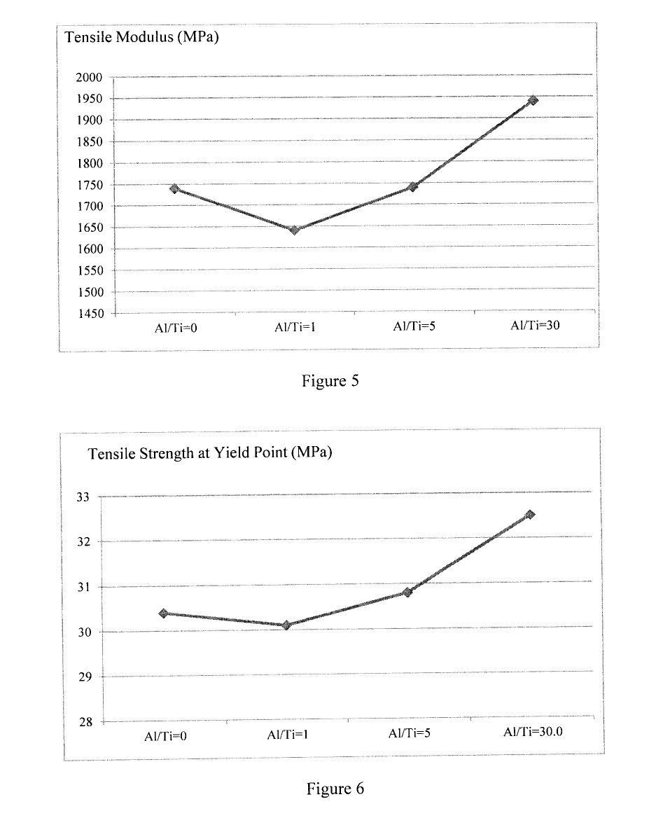

FIGS. 5 and 6 shows mechanical properties of the polymer resulted from ethylene polymerization reaction using different catalysts. When comparing polymers from example Cat T2 and Cat T3 with the polymer from comparative example Cat NT, it was found that catalyst treated with organoaluminium compound at the mole ratio of Al/Ti in the range of 5 to 30 resulted in the polymer with higher strength considered from higher tensile modulus and tensile strength at yield point.

From the results above, it can be said that the catalyst prepared by the process according to the invention has high activity in olefin polymerization, resulting in good mechanical properties of the polymer, and has narrow molecular weight distribution, wherein said process can be perform easily, reducing complicated steps, and can be performed at low temperature as provided in the objectives of this invention.

### BEST MODE OF THE INVENTION

Best mode or preferred embodiment of the invention is as provided in the description of the invention.

1. A method for preparing high activity ethylene polymerization catalyst, wherein said method comprising the following steps:
(a) adding magnesium halide into alcohol solvent selected from ethanol, isopropanol, butanol, hexanol, 2-hexanol, octanol, or a mixture thereof;
(b) precipitating solution from (a) in solution of organic solvent containing organo compound of group III element;
(c) adding titanium compound selected from trialkoxy titanium monochloride, dialkoxy titanium dichloride, alkoxy titanium trichloride, titanium halide, or a mixture thereof into mixture from (b) to obtain a catalyst;
(d) treating the catalyst obtained from (c) with organoaluminium compound selected from trialkylaluminium, alkylaluminium alkoxide, alkylaluminium halide, or a mixture thereof at temperature ranging from 0 to 60° C. for 2 to 5 hours, wherein a mole ratio of aluminium to titanium (Al/Ti) for treatment is in a range of 1 to 30.

2. The method for preparing catalyst according to claim 1, wherein
magnesium halide in step (a) is selected from magnesium dichloride, magnesium dibromide, or a mixture thereof.

3. The method for preparing catalyst according to claim 2, wherein magnesium halide is magnesium dichloride.

4. The method for preparing catalyst according to claim 1, wherein organo compound of group III element in step (b) is alkyl compound of group III element, tris(halophenyl)borane, alkylaluminium alkoxide, dialkylaluminium chloride, or a mixture thereof.

5. The method for preparing catalyst according to claim 4, wherein alkyl compound of group III element is selected from trimethylaluminium, triethylaluminium, triisobutylaluminium, tripropylaluminium, trimethylborane, triethylborane, triisobutylborane, or a mixture thereof.

6. The method for preparing catalyst according to claim 4, wherein tris(halophenyl)borane is selected from tris(pentafluorophenyl)borane, tris(trifluoromethylphenyl)borane, tris(tetrafluoroxylyl)borane, tris(tetrafluoro-o-tolyl)borane, or a mixture thereof.

7. The method for preparing catalyst according to claim 4, wherein alkylaluminium alkoxide is selected from diethylaluminium ethoxide, ethylaluminium diethoxide, diisobutyl aluminium ethoxide, or a mixture thereof.

8. The method for preparing catalyst according to claim 4, wherein dialkylaluminium chloride is selected from dimethylaluminium chloride, diethylaluminium chloride, diisobutylaluminium chloride, or a mixture thereof.

9. The method for preparing catalyst according to claim 8, wherein dialkylaluminium chloride is diethylaluminium chloride.

10. (canceled)

11. (canceled)

12. The method for preparing catalyst according to claim 1, wherein titanium compound in step (c) is selected from titanium halide.

13. The method for preparing catalyst according to claim 12, wherein titanium halide is titanium chloride.

14. (canceled)

15. The method for preparing catalyst according to claim 1, wherein organoaluminium compound in step (d) is selected from trimethylaluminium, triethylaluminium, triisobutylaluminium, tripropylaluminium, diethylaluminium ethoxide, ethylaluminium diethoxide, diisobutyl aluminium ethoxide, dimethylaluminium chloride, diethylaluminium chloride, diisobutylaluminium chloride, methylaluminium dichloride, ethylaluminium dichloride, isobutylaluminium dichloride, aluminium trichloride, or a mixture thereof.

16. The method for preparing catalyst according to claim 15, wherein organoaluminium compound is triethylaluminium.

17. (canceled)

18. (canceled)

19. The method for preparing catalyst according to claim 1, wherein the mole ratio of aluminium to titanium for treating in step (d) is in the range of 1 to 10.

20. The method for preparing catalyst according to claim 19, wherein the mole ratio of aluminium to titanium for treating in step (d) is in the range of 1 to 5.

21. The method for preparing catalyst according to claim 1, wherein treatment temperature in step (d) is in the range of 0° C. to room temperature.

22. The method for preparing catalyst according to claim 21, wherein treatment temperature is ambient temperature.

23. The method for preparing catalyst according to claim 1, wherein treatment time in step (d) is in the range of 2 to 3 hours.

24. The method for preparing catalyst according to claim 1, further comprising a drying step.

25. (canceled)

26. (canceled)

27. The method for preparing catalyst according to claim 1, wherein alcohol solvent is ethanol.
